(19) United States
(12) Patent Application Publication
(10) Pub. No.: US 2015/0311573 A1
(43) Pub. Date: Oct. 29, 2015

(54) SIT ON TOP CIRCUIT BOARD FERRITE PHASE SHIFTER

(71) Applicant: Honeywell International Inc., Morristown, NJ (US)

(72) Inventor: Jeffrey Alexander, Atlanta, GA (US)

(73) Assignee: Honeywell International Inc., Morristown, NJ (US)

(21) Appl. No.: 14/260,368

(22) Filed: Apr. 24, 2014

(51) Int. Cl. H01P 1/18

(52) U.S. Cl. CPC H01P 1/195

(57) ABSTRACT

Systems and methods for sit on top circuit board ferrite phase shifters are provided. In at least one embodiment, the system comprises a waveguide ferrite phase shifter configured to propagate electromagnetic energy longitudinally between the ends of the waveguide ferrite phase shifter, a stripline circuit board that includes a conductive trace, and one or more conductive pins configured to couple electromagnetic energy between the conductive trace and an end of the waveguide ferrite phase shifter. The waveguide ferrite phase shifter comprises at least one ferromagnetic core that extends longitudinally between the ends of the waveguide ferrite phase shifter, at least one dielectric slab that abuts one side of the ferromagnetic core and extends longitudinally through the waveguide ferrite phase shifter against the ferromagnetic core, and a metalized rectangular housing that encases the ferromagnetic core and the dielectric slab and extends longitudinally between the ends of the waveguide ferrite phase shifter.

### BACKGROUND

Phase shifters play an important role in many radio frequency (RF) circuit applications (e.g., in phased antenna arrays). Ferrite phase shifters are the preferred type of phase shifters used in non-active RF applications because of their low insertion loss, high power handling, fast switching, high resolution and high accuracy. While ferrite phase shifters are the preferred type of phase shifter, they are not easily integrated into stripline based RF circuit boards, which provide the dominant medium for RF circuits. Instead, in conventional implementations, ferrite phase shifters are often times interfaced with microstrip line boards.

### SUMMARY

Systems and methods for sit on top circuit board ferrite phase shifters are provided. In at least one embodiment, the system comprises a waveguide ferrite phase shifter configured to propagate electromagnetic energy longitudinally between a first and second end of the waveguide ferrite phase shifter, a stripline circuit board, wherein the stripline circuit board has at least one conductive trace, and one or more conductive pins configured to couple electromagnetic energy between the at least one conductive trace and one of the first or second ends of the waveguide ferrite phase shifter. The waveguide ferrite phase shifter comprises at least one ferromagnetic core that extends longitudinally between the first and the second ends of the waveguide ferrite phase shifter, one or more dielectric slabs that abut one side of the ferromagnetic core and extends longitudinally through the waveguide ferrite phase shifter against the at least one ferromagnetic core, and a metalized rectangular housing that encases the at least one ferromagnetic core and the at least one dielectric slab and extends longitudinally between the first and second ends of the waveguide ferrite phase shifter.

### DRAWINGS

Understanding that the drawings depict only exemplary embodiments and are not therefore to be considered limiting in scope, the exemplary embodiments will be described with additional specificity and detail through the use of the accompanying drawings, in which:

FIGS. 1A-1B are diagrams of examples of sit on top stripline circuit board ferrite phase shifters;

FIG. 2 is a diagram of an example of a portion of the waveguide ferrite phase shifter shown in FIG. 1A;

FIG. 3 is a diagram of an example of a portion of the stripline circuit board shown in FIGS. 1A-2; and

FIG. 4 is a flow diagram of an example method for constructing a sit on top stripline circuit board ferrite phase shifter.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

The embodiments described within this disclosure address the problem of integrating ferrite phase shifters with striplines, which makes the integration much simpler, cleaner, higher performing (i.e., less transition obstacles) and more cost effective. The embodiments described herein do so by configuring a pin to couple electromagnetic energy between a conductive trace in a stripline circuit board and a waveguide ferrite phase shifter.

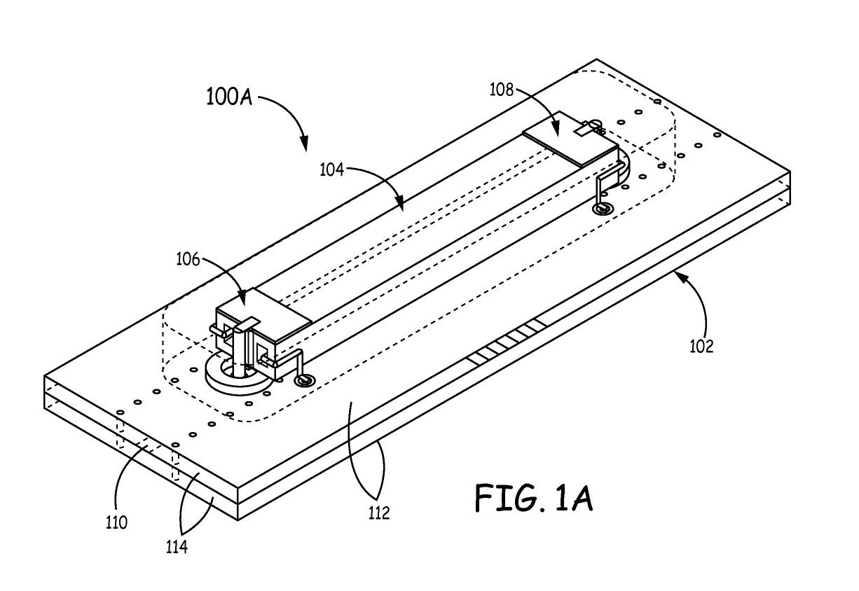

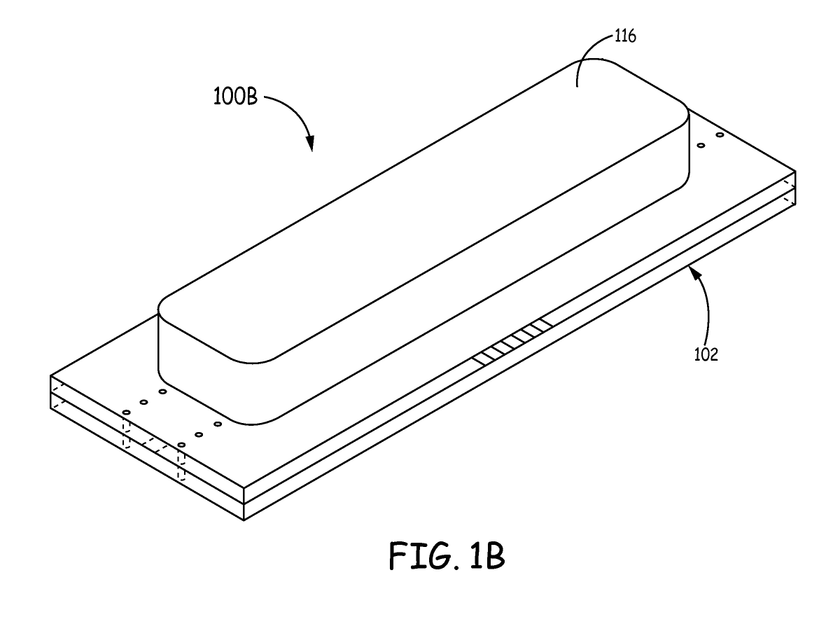

FIG. 1A is a diagram of an example of a sit on top stripline circuit board ferrite phase shifter 100A. In certain exemplary embodiments, a sit on top stripline circuit board ferrite phase shifter 100A includes a stripline circuit board 102 and a waveguide ferrite phase shifter 104. A waveguide ferrite phase shifter 104 is an RF component that transfers an electromagnetic signal between the first 106 and second 108 ends of the waveguide ferrite phase shifter 104 and shifts the phase of the electromagnetic signal that passes through the waveguide ferrite phase shifter 104. More detail about the waveguide ferrite phase shifter 104 is given below.

A stripline circuit board 102 is an electromagnetic transmission line medium that has a conductive trace 110 to transport electromagnetic energy. The conductive trace 110 is a strip of conductive material disposed between two parallel ground plates 112. Moreover, a dielectric 114 separates the conductive trace 110 from the two parallel ground plates 112. The width of the conductive trace 110 along with the thickness and permittivity of the dielectric 114 determine the characteristic impedance of the stripline circuit board 102. The characteristic impedance of the stripline circuit board 102 may be matched by other parts of the sit on top circuit board ferrite phase shifter 100A as discussed in more detail below. The waveguide ferrite phase shifter 104 is cleanly integrated into the stripline circuit board 102 without the need for a microstrip transition, as in conventional embodiments.

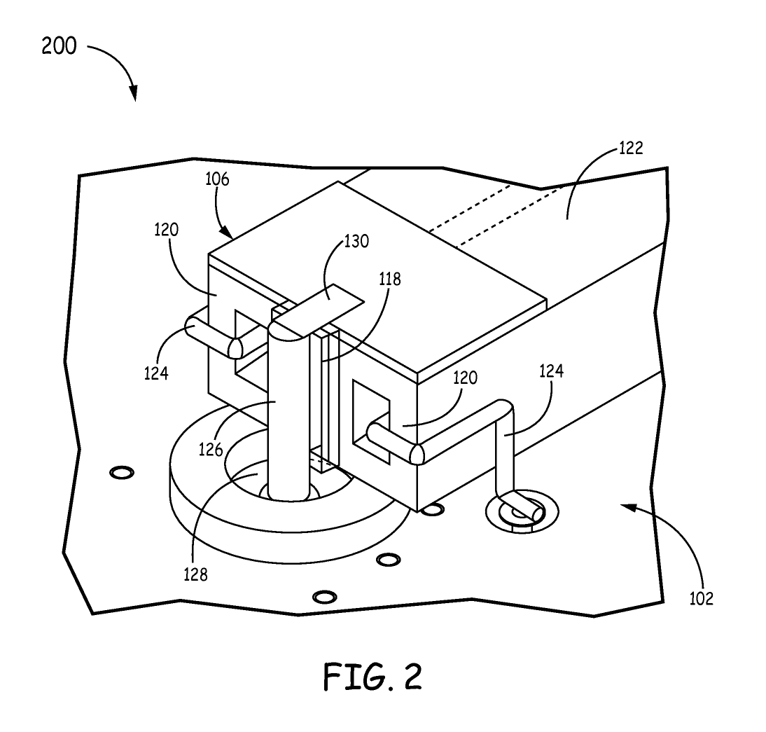

FIG. 1B is a diagram of an example of the waveguide ferrite phase shifter 104 shown in FIG. 1A with an electromagnetic shield 116 over the waveguide ferrite phase shifter 104. In some embodiments, an electromagnetic shield 116 is designed to encase the waveguide ferrite phase shifter 104 and any components that couple electromagnetic energy from the stripline circuit board 102 into the ends of the waveguide ferrite phase shifter 104. (See FIG. 2 for more detail on the components that couple electromagnetic energy from the stripline circuit board 102 into the ends of the waveguide ferrite phase shifter 104.) In some embodiments, the electromagnetic shield 116 can be made of metal or other conductive materials and can be soldered or otherwise conductively attached to the metal surface of the stripline board 102 and to the metal plating and/or metal casing of the waveguide ferrite phase shifter 104. In some embodiments, the purpose of the electromagnetic shield 116 can be to prevent any outside electromagnetic field from interacting with the components under the shield 116. This can be especially important in cases where the waveguide ferrite phase shifter 104 is placed in an array with other ferrite phase shifters 104. Moreover, the electromagnetic shield 116 can also prevent electromagnetic fields from leaking out of the waveguide ferrite phase shifter 104 apparatus, which could affect other nearby components.

FIG. 2 is a diagram of an example of one end of the waveguide ferrite phase shifter 104 shown in FIG. 1A. The waveguide ferrite phase shifter 104 is a waveguide loaded with a dielectric 118 and a ferromagnetic core 120. In exemplary embodiments, the ferromagnetic core 120 has a toroidal cross section. The waveguide ferrite phase shifter 104 includes a metalized rectangular housing 122 that encloses the dielectric 118 and ferromagnetic core 120. In exemplary embodiments, the metalized rectangular housing 122 encloses two ferromagnetic cores 120 with toroidal cross sections, which are separated by a dielectric 118 having a relatively high dielectric constant. This structure of a waveguide ferrite phase shifter 104 is known as a twin toroid phase shifter and is used throughout the rest of the disclosure; however, other configurations of the metallized rectangular housing 122, ferromagnetic core(s) 120 and dielectric(s) 118 are possible in other alternative embodiments. The signal propagating through the waveguide ferrite phase shifter 104 undergoes a predetermined phase shift per unit length which is varied by setting the level of magnetization in the ferromagnetic cores 120. The level of magnetization in the ferromagnetic cores 120 can be set by passing a current through a latch wire 124 that passes through the centers of the ferromagnetic cores 120.

In at least one embodiment, an electromagnetic signal travels from the one or more conductive traces 110 (shown in FIG. 1A) on the stripline circuit board 102 to one or more conductive pins 126 configured to couple the electromagnetic energy between the one or more conductive traces 110 to one end of the first 106 or second 108 ends of the waveguide ferrite phase shifter 104. In this example, the conductive pin 126 is coupling electromagnetic energy from the conductive trace 110 to the first end 106 of the waveguide ferrite phase shifter 104. While only the first end 106 of the waveguide ferrite phase shifter 104 is shown, in some embodiments, the second end 108 of the waveguide ferrite phase shifter 104 can be the same as the first end 106. As stated above, once the conductive pin 126 couples the electromagnetic energy into the waveguide ferrite phase shifter 104, the waveguide ferrite phase shifter 104 is configured to propagate the electromagnetic energy as an electromagnetic wave longitudinally between a first end 106 and a second end 108 of the waveguide ferrite phase shifter 104.

As discussed above, the waveguide ferrite phase shifter 104 shifts the phase of an electromagnetic wave that passes through the waveguide ferrite phase shifter 104 using one or more ferromagnetic cores 120 that extend longitudinally between the first 106 and second 108 ends of the waveguide ferrite phase shifter 104. In some embodiments, the one or more ferromagnetic cores 120 have toroidal cross sections. In other embodiments, different cross sections of the ferromagnetic cores 120 can be used. FIG. 2 is an example where the one or more ferromagnetic cores 120 comprise two ferromagnetic cores 120 each with a toroidal cross section that extends longitudinally between the first 106 and second 108 ends of the waveguide ferrite phase shifter 104. The ferromagnetic cores 120 are composed of ferrite which is a non-reciprocal material where the relationship between an oscillating current and the resulting electric fields changes if the location where the current is placed and where the field is measured changes. To control the frequency response of the ferromagnetic core 120, the cross sectional size of the ferromagnetic core 120 is selected accordingly. Moreover, the ferrite material used to fabricate the ferromagnetic core 120 can be selected based on its magnetization characteristics to achieve a desired frequency response.

The waveguide ferrite phase shifter 104 also includes one or more dielectric slabs 118 that abut one side of the one or more ferromagnetic cores 120 for which the electromagnetic energy, in the form of a wave, propagates through. The one or more dielectric slabs 118 extend along the longitudinal axis of the ferromagnetic core 120. In exemplary embodiments, there is one dielectric slab 118 that is sandwiched between the two ferromagnetic cores 120. The dielectric slab 118 in this embodiment serves the same purpose as a dielectric center core, except that the dielectric constant of the dielectric slab 118 can be significantly higher than the dielectric constant of the center core of the ferromagnetic cores 120. As a result, more wavelengths of RF interaction are possible for a given physical length which makes this twin toroidal design more mass efficient than a single toroid design. Further, unlike other designs, the twin toroidal design provides a thermal path to remove heat from the toroid generated by RF power dissipation. In some embodiments, the ferromagnetic cores 120 and the dielectric slabs 118 can be secured using an epoxy and metalized. Using this twin toroidal configuration, the most RF-active ferrite in the ferromagnetic core 120 is located on each side of the dielectric slab 118. The outer portions of the ferromagnetic cores 120 are relatively inactive and serve merely to complete a magnetic path and allowing latching operations as explained below.

Further, as explained above, the waveguide ferrite phase shifter 104 includes a metalized rectangular housing 122 that encapsulates the one or more ferromagnetic cores 120 and the one or more dielectric slabs 118. In exemplary embodiments, the metalized rectangular housing 122 is a substrate that includes a metal coating such as copper and/or gold. In other embodiments, the metalized rectangular housing 122 can be a full metal casing. The metalized rectangular housing 122 encapsulates the one or more ferromagnetic cores 120 and the one or more dielectric slabs 118 along their longitudinal axis to create a waveguide structure. The width of the metalized rectangular housing 122 can be chosen depending on the wavelength of the RF energy that passes through the waveguide ferrite phase shifter 104, wherein RF energy with wavelengths more than twice the width of the metalized rectangular housing 122 will not propagate in the waveguide ferrite phase shifter 104.

In some embodiments, one or more conductive latch wires 124 extend through the middle of the one or more ferromagnetic cores 120 from the first end 106 to the second end 108 of the waveguide ferrite phase shifter 104. The latch wire 124 can magnetize the ferromagnetic core 120 to a desired degree of magnetization by passing a current through the latch wire 124, which will in turn create a magnetic field surrounding the latch wire 124 and magnetize the ferromagnetic core 120. The magnetized ferromagnetic core 120 will shift any electromagnetic signal passing through the waveguide ferrite phase shifter 104. The level of shift experienced by the electromagnetic signal will depend on the level of magnetization of the ferromagnetic core 120. In some embodiments, the latch wire 124 can come out at the end of the ferromagnetic core 120 and be soldered down to a via pad on the stripline circuit board 102 as shown in FIG. 2.

As stated above, a pin 126 couples electromagnetic energy between the conductive trace 110 (shown in FIG. 1A) in the stripline circuit board 102 and one end of the first 106 or second 108 ends of the waveguide ferrite phase shifter 104. Stated another way, the pin 126 launches the electromagnetic energy out of the stripline circuit board 102 into the waveguide ferrite phase shifter 104, where the electromagnetic energy is in a waveguide mode in the ferrite phase shifter 104. The pin 126 can also receive electromagnetic energy from waveguide ferrite phase shifter 104 and transfer it to the stripline circuit board 102. As a result, there is no need for an additional interface to get the electromagnetic energy into and out of the stripline board, as is the case in conventional implementations.

To integrate the pin 126 into the stripline circuit board 102, a via 128 is created in the stripline circuit board 102. The pin 126 is then inserted inside the via 128 and electrically connected to the stripline circuit board 102, such as soldering the pin 126 to the stripline circuit board 102, so that an electromagnetic signal can travel between the stripline circuit board 102 and the pin 126. The pin 126 and the via 128 can function similar to a coaxial wire. In exemplary embodiments, the distance from the sides of the via 128 to the pin 126 can be chosen so the characteristic impedance of the pin 126 and the via 128 matches the characteristic impedance of the stripline circuit board 102, according to the characteristic impedance formula,

$$i . e . , {Z}_{0} \approx \frac{138 Ω}{\sqrt{{ɛ}_{r}}} {log}_{10} \frac{{D}_{1}}{{d}_{1}} ,$$

where D₁ is the distance of the pin 126 from the sides of the via 128, d₁ is the diameter of the pin 126 inside the via 128 and ∈ᵣ is the relative dielectric constant.

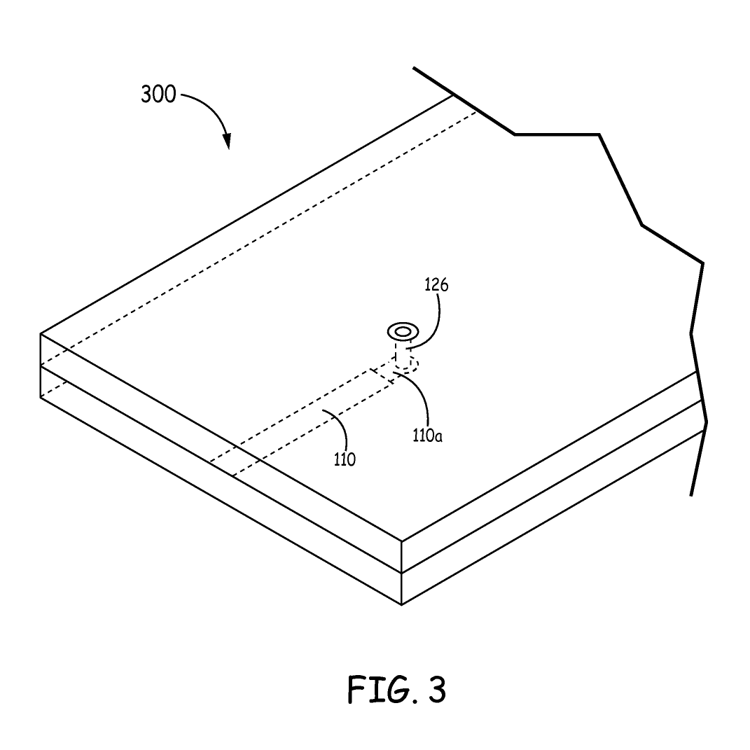

In addition to choosing the correct dimensions of the via 128 and the pin 126, in some embodiments, the apparatus 200 can be designed as follows to help tune and match impedances in the apparatus 200. The cross section of the ferrite phase shifter 104 can be chosen to match the impedance of the stripline circuit board 102. That is, the height and width of the ferromagnetic cores 120 and dielectric 118 can be chosen based on the desired frequency bandwidth and power handling demands that were chosen for the stripline circuit board 102. Once the ferrite phase shifter 104 and the stripline circuit board 102 are chosen to have matching impedances, the following can be varied in order to tune the apparatus 200, wherein exact values for each of the following characteristics can be obtained by routine experimentation. First, the distance between the pin 126 and the end of the ferrite phase shifter 104 can be varied to help match impedances. Second, a series capacitor can be inserted between the pin 126 and the waveguide ferrite phase shifter 104, wherein the length of the series capacitor can be varied. In at least one embodiments, the series capacitance is created by coupling a metal strip 130 to the end of the pin 126. The separation of the metal strip 130 from the metalized rectangular housing 122 can be the length of the capacitor. Third, the width of the conductive trace 110 immediately before the pin 126 can be varied, as shown in FIG. 3. More specifically, FIG. 3 is the stripline circuit board 102 in FIGS. 1A-2 without the two parallel ground plates 112. The width 110a of the conductive trace 110 near where the pin 126 is coupled to the conductive trace 110 can be different than the width of the conductive trace 110 away from the pin 126 in order to help match impedances, as is shown in FIG. 3.

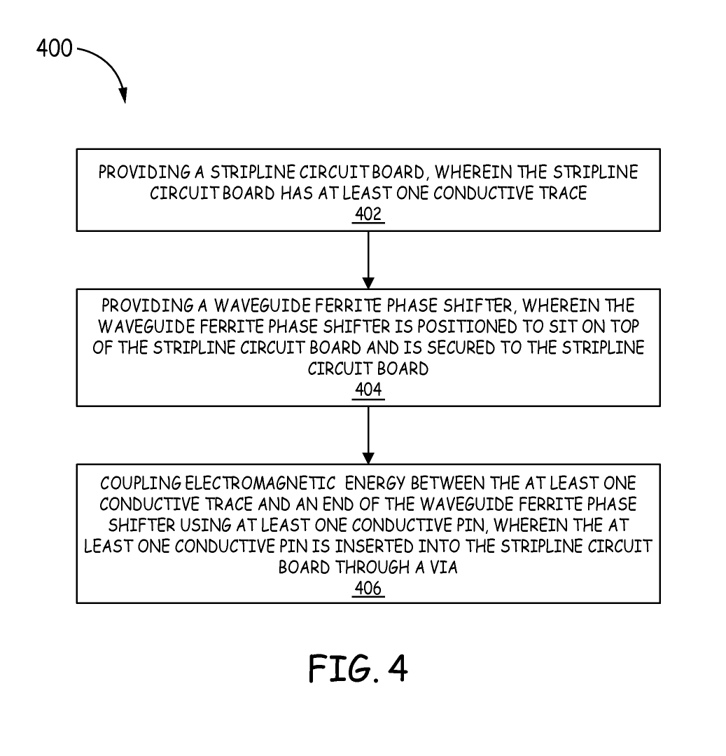

FIG. 4 is a flow diagram of an example method 400 for constructing a sit on top stripline circuit board ferrite phase shifter. The method 400 comprises providing a stripline circuit board, wherein the stripline circuit board has one or more conductive traces (block 402). In some embodiments, the stripline circuit board and the one or more conductive traces can have some or all of the characteristics of the stripline circuit board 102 and the one or more conductive traces 110 discussed above under FIGS. 1A-3.

Additionally, method 400 comprises providing a waveguide ferrite phase shifter, wherein the waveguide ferrite phase shifter is positioned to sit on top of the stripline circuit board and is secured to the stripline circuit board (block 404). In some embodiments, the positioning of the waveguide ferrite phase shifter can be the same or similar to how the waveguide ferrite phase shifter 104 is positioned on the stripline circuit board 102 in FIGS. 1A-2. Moreover, the waveguide ferrite phase shifter can have some or all of the same characteristics as the waveguide ferrite phase shifters 104 discussed above in FIGS. 1A-2. For example, the waveguide ferrite phase shifter can be comprised of one or more ferromagnetic cores with a toroidal cross section that extends longitudinally between the first and the second ends of the waveguide ferrite phase shifter and at least one dielectric slab that abuts one side of the ferromagnetic core and extends along the longitudinal axis of the ferromagnetic core. In exemplary embodiments, the waveguide ferrite phase shifter comprises two ferromagnetic cores each with a toroidal cross section and one dielectric slab disposed between the two ferromagnetic cores. Moreover, the waveguide ferrite phase shifter can include one or more conductive latch wires extending through the center of the one or more ferromagnetic cores and can be secured to the stripline circuit board by soldering the waveguide ferrite phase shifter to the stripline circuit board. The characteristic impedance of the waveguide ferrite phase shifter can also be chosen to match the characteristic impedance of the stripline circuit board.

Method 400 further comprises coupling electromagnetic energy between the at least one conductive trace and an end of the waveguide ferrite phase shifter using at least one conductive pin, wherein the at least one conductive pin is inserted into the stripline circuit board through a via (block 406). The one or more conductive pins and the via can have some or all of the same characteristics as the one or more conductive pins 126 and the via 128 discussed above under FIG. 2. That is, in some embodiments, the distance from the sides of the via to the pin can be chosen so the characteristic impedance of the pin and the via match the characteristic impedance of the stripline circuit board. Further, in some embodiments, some or all of the following tuning methods can be used to help match the characteristic impedances of the waveguide ferrite phase shifter, the pin and the stripline circuit board: the pin can be separated from the waveguide ferrite phase shifter by a dielectric, wherein the separation is varied for tuning purposes; a series capacitor can be inserted between the at least one conductive pin and the waveguide ferrite phase shifter; and, the width of the conductive trace near where the pin is coupled to the conductive trace can be varied. In some embodiments, the one or more pins and the waveguide phase shifter can be surrounded by an electromagnetic shield, such as a metal casing.

### Example Embodiments

Example 1 includes a system comprising: a waveguide ferrite phase shifter configured to propagate electromagnetic energy longitudinally between a first and second end of the waveguide ferrite phase shifter comprising: at least one ferromagnetic core that extends longitudinally between the first and the second ends of the waveguide ferrite phase shifter, at least one dielectric slab that abuts one side of the ferromagnetic core and extends longitudinally through the waveguide ferrite phase shifter against the at least one ferromagnetic core, and a metalized rectangular housing that encases the at least one ferromagnetic core and the at least one dielectric slab and extends longitudinally between the first and second ends of the waveguide ferrite phase shifter; a stripline circuit board, wherein the stripline circuit board has at least one conductive trace; and at least one conductive pin configured to couple electromagnetic energy between the at least one conductive trace and one of the first or second ends of the waveguide ferrite phase shifter.

Example 2 includes the system of Example 1, wherein at least one conductive latch wire extends through the at least one ferromagnetic core from the first end to the second end of the waveguide ferrite phase shifter.

Example 3 includes the system of any of Examples 1-2, wherein a first conductive pin of the at least one conductive pins couples electromagnetic energy between a first conductive trace of the at least one conductive trace and the first end of the waveguide phase shifter and a second conductive pin of the at least one conductive pins couples electromagnetic energy between a second conductive trace of the at least one conductive trace and the second end of the waveguide phase shifter.

Example 4 includes the system of any of Examples 1-3, wherein the at least one ferromagnetic core comprises two ferromagnetic cores each with toroidal cross sections and the at least one dielectric slab comprises one dielectric slab that is disposed between the two ferromagnetic cores.

Example 5 includes the system of any of Examples 1-4, wherein an electromagnetic shield surrounds the waveguide ferrite phase shifter and the at least one conductive pin that is coupling electromagnetic energy between the at least one conductive trace and the one end of the first or second ends of the waveguide ferrite phase shifter.

Example 6 includes the system of any of Examples 1-5, wherein the at least one conductive pin and the one of the first or second ends of the waveguide phase shifter are separated by a dielectric.

Example 7 includes the system of any of Examples 1-6, wherein a series capacitor is inserted between the at least one conductive pin and the waveguide ferrite phase shifter.

Example 8 includes the system of any of Examples 1-7, wherein the width of the at least conductive trace is varied in order to aid in matching the impedance of the stripline circuit board with the at least one conductive pin.

Example 9 includes the system of any of Examples 1-8, wherein the characteristic impedance of the waveguide ferrite phase shifter is substantially equal to the characteristic impedance of the stripline circuit board.

Example 10 includes a method for constructing a sit on top stripline circuit board ferrite phase shifter, the method comprising: providing a stripline circuit board, wherein the stripline circuit board has at least one conductive trace; providing a waveguide ferrite phase shifter, wherein the waveguide ferrite phase shifter is positioned to sit on top of the stripline circuit board and is secured to the stripline circuit board; and coupling electromagnetic energy between the at least one conductive trace and an end of the waveguide ferrite phase shifter using at least one conductive pin, wherein the at least one conductive pin is inserted into the stripline circuit board through a via.

Example 11 includes the method of Example 10 further comprising separating the at least one conductive pin from the waveguide ferrite phase shifter by a dielectric in order to aid in matching the impedance of the at least one conductive pin with the impedance of the at least one waveguide ferrite shifter.

Example 12 includes the method of any of Examples 10-11 further comprising inserting a series capacitor between the at least one conductive pin and the waveguide ferrite phase shifter in order to aid in matching the impedance of the at least one conductive pin with the impedance of the at least one waveguide ferrite shifter.

Example 13 includes the method of any of Examples 10-12 further comprising varying the width of the at least conductive trace in order to aid in matching the impedance of the stripline circuit board with the at least one conductive pin.

Example 14 includes the method of any of Examples 10-14 wherein the at least one conductive pin and the waveguide phase shifter are surrounded by an electromagnetic shield.

Example 15 includes the method of any of Examples 10-15 wherein the characteristic impedance of the waveguide ferrite phase shifter is substantially equal to the characteristic impedance of the stripline circuit board.

Example 16 includes the method of Example 10, wherein the waveguide ferrite phase shifter comprises at least one ferromagnetic core with a toroidal cross section that extends longitudinally between the first and the second ends of the waveguide ferrite phase shifter and at least one dielectric slab that abuts one side of the ferromagnetic core and extends along the longitudinal axis of the ferromagnetic core.

Example 17 includes the method of Example 16 further comprising at least one conductive latch wire extending through the at least one ferromagnetic core.

Example 18 includes the method of any of Examples 16-18 wherein the waveguide ferrite phase shifter comprises two ferromagnetic cores each with a toroidal cross section and one dielectric slab disposed between the two ferromagnetic cores.

Example 19 includes an apparatus comprising: at least one conductive pin configured to couple electromagnetic energy between at least one conductive trace in a stripline circuit board and a waveguide ferrite phase shifter wherein the at least one conductive pin is separated from the waveguide ferrite phase shifter by a dielectric.

Example 20 includes the apparatus of any of Examples 19-20 wherein the at least one conductive pin is surrounded by an electromagnetic shield.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system comprising:
a waveguide ferrite phase shifter configured to propagate electromagnetic energy longitudinally between a first and second end of the waveguide ferrite phase shifter comprising:
at least one ferromagnetic core that extends longitudinally between the first and the second ends of the waveguide ferrite phase shifter,
at least one dielectric slab that abuts one side of the ferromagnetic core and extends longitudinally through the waveguide ferrite phase shifter against the at least one ferromagnetic core, and
a metalized rectangular housing that encases the at least one ferromagnetic core and the at least one dielectric slab and extends longitudinally between the first and second ends of the waveguide ferrite phase shifter;
a stripline circuit board, wherein the stripline circuit board has at least one conductive trace; and
at least one conductive pin configured to couple electromagnetic energy between the at least one conductive trace and one of the first or second ends of the waveguide ferrite phase shifter.

2. The system of claim 1, wherein at least one conductive latch wire extends through the at least one ferromagnetic core from the first end to the second end of the waveguide ferrite phase shifter.

3. The system of claim 1, wherein a first conductive pin of the at least one conductive pins couples electromagnetic energy between a first conductive trace of the at least one conductive trace and the first end of the waveguide phase shifter and a second conductive pin of the at least one conductive pins couples electromagnetic energy between a second conductive trace of the at least one conductive trace and the second end of the waveguide phase shifter.

4. The system of claim 1, wherein the at least one ferromagnetic core comprises two ferromagnetic cores each with toroidal cross sections and the at least one dielectric slab comprises one dielectric slab that is disposed between the two ferromagnetic cores.

5. The system of claim 1, wherein an electromagnetic shield surrounds the waveguide ferrite phase shifter and the at least one conductive pin that is coupling electromagnetic energy between the at least one conductive trace and the one end of the first or second ends of the waveguide ferrite phase shifter.

6. The system of claim 1, wherein the at least one conductive pin and the one of the first or second ends of the waveguide phase shifter are separated by a dielectric.

7. The system of claim 1, wherein a series capacitor is inserted between the at least one conductive pin and the waveguide ferrite phase shifter.

8. The system of claim 1, wherein the width of the at least conductive trace is varied in order to aid in matching the impedance of the stripline circuit board with the at least one conductive pin.

9. The system of claim 1, wherein the characteristic impedance of the waveguide ferrite phase shifter is substantially equal to the characteristic impedance of the stripline circuit board.

10. A method for constructing a sit on top stripline circuit board ferrite phase shifter, the method comprising:
providing a stripline circuit board, wherein the stripline circuit board has at least one conductive trace;
providing a waveguide ferrite phase shifter, wherein the waveguide ferrite phase shifter is positioned to sit on top of the stripline circuit board and is secured to the stripline circuit board; and
coupling electromagnetic energy between the at least one conductive trace and an end of the waveguide ferrite phase shifter using at least one conductive pin, wherein the at least one conductive pin is inserted into the stripline circuit board through a via.

11. The method of claim 10 further comprising separating the at least one conductive pin from the waveguide ferrite phase shifter by a dielectric in order to aid in matching the impedance of the at least one conductive pin with the impedance of the at least one waveguide ferrite shifter.

12. The method of claim 10 further comprising inserting a series capacitor between the at least one conductive pin and the waveguide ferrite phase shifter in order to aid in matching the impedance of the at least one conductive pin with the impedance of the at least one waveguide ferrite shifter.

13. The method of claim 10 further comprising varying the width of the at least conductive trace in order to aid in matching the impedance of the stripline circuit board with the at least one conductive pin.

14. The method of claim 10 wherein the at least one conductive pin and the waveguide phase shifter are surrounded by an electromagnetic shield.

15. The method of claim 10 wherein the characteristic impedance of the waveguide ferrite phase shifter is substantially equal to the characteristic impedance of the stripline circuit board.

16. The method of claim 10, wherein the waveguide ferrite phase shifter comprises at least one ferromagnetic core with a toroidal cross section that extends longitudinally between the first and the second ends of the waveguide ferrite phase shifter and at least one dielectric slab that abuts one side of the ferromagnetic core and extends along the longitudinal axis of the ferromagnetic core.

17. The method of claim 16 further comprising at least one conductive latch wire extending through the at least one ferromagnetic core.

18. The method of claim 16 wherein the waveguide ferrite phase shifter comprises two ferromagnetic cores each with a toroidal cross section and one dielectric slab disposed between the two ferromagnetic cores.

19. An apparatus comprising:
at least one conductive pin configured to couple electromagnetic energy between at least one conductive trace in a stripline circuit board and a waveguide ferrite phase shifter wherein the at least one conductive pin is separated from the waveguide ferrite phase shifter by a dielectric.

20. The apparatus of claim 19 wherein the at least one conductive pin is surrounded by an electromagnetic shield.
